(19) United States
(12) Patent Application Publication
(10) Pub. No.: US 2025/0343479 A1
(43) Pub. Date: Nov. 6, 2025

(54) POWER CONVERTER AND Y-CAPACITOR

(71) Applicant: DENSO CORPOATION, Kariya-city (JP)

(72) Inventors: Takaaki KITAMORI, Kariya-city (JP); Shintaro Kogure, Kariya-city (JP)

(73) Assignee: DENSO CORPOATION, Kariya-city (JP)

(21) Appl. No.: 19/264,199

(22) Filed: Jul. 9, 2025

Related U.S. Application Data
(63) Continuation of application No. PCT/JP2023/044021, filed on Dec. 8, 2023.

(30) Foreign Application Priority Data
Feb. 8, 2023 (JP) 2023-017841

(51) Int. Cl. H02M 1/44; H02M 7/537

(52) U.S. Cl. CPC H02M 1/44; H02M 7/537

(57) ABSTRACT

A power converter includes an inverter that converts electric power from a battery and a Y-capacitor to reduce noise generated by the inverter. The converter has a case housing both the inverter and the Y-capacitor. The Y-capacitor includes a P-side element with a first terminal connected to the inverter and a second terminal connected to the case, and an N-side element with a third terminal connected to the inverter and a fourth terminal connected to the case. A GND busbar connects the second and fourth terminals to the case, grounding both Y-capacitor elements. The P-side and N-side Y-capacitor elements do not face each other in the direction of their respective terminals' arrangement, enhancing noise reduction performance.

### CROSS REFERENCE TO RELATED APPLICATIONS

The present application is a continuation application of International Patent Application No. PCT/JP2023/044021 filed on Dec. 8, 2023, which designated the U.S. and claims the benefit of priority from Japanese Patent Application No. 2023-017841 filed on Feb. 8, 2023. The entire disclosures of all of the above applications are incorporated herein by reference.

### TECHNICAL FIELD

The present disclosure relates to a power converter and a Y-capacitor.

### BACKGROUND

A conventional power converter includes a switching element, and two Y-capacitors for reducing noise current generated by the switching element.

### SUMMARY

According to at least one embodiment, a power converter includes an inverter that converts electric power supplied from a battery. The power converter has a Y-capacitor for reducing noise generated in the inverter. The power converter also includes a case that houses the inverter and the Y-capacitor. The Y-capacitor includes a P-side Y-capacitor element, which has a first terminal electrically connected to the inverter and a second terminal electrically connected to the case. The Y-capacitor also includes an N-side Y-capacitor element, which has a third terminal electrically connected to the inverter and a fourth terminal electrically connected to the case. Additionally, the Y-capacitor has a GND busbar connected to the second terminal, the fourth terminal, and the case. The GND busbar connects the P-side Y-capacitor element and the N-side Y-capacitor element with ground. The P-side Y-capacitor element and the N-side Y-capacitor element may not face each other either in a first direction, in which the first terminal and the second terminal are arranged, or in a second direction, in which the third terminal and the fourth terminal are arranged.

### BRIEF DESCRIPTION OF DRAWINGS

The details of one or more embodiments are set forth in the accompanying drawings and the description below. Other features and advantages will be apparent from the description and drawings, and from the claims.

FIG. 1 is an electrical circuit diagram of a power converter.

FIG. 2 is a plan view of the power converter as viewed from a first storage space.

FIG. 3 is a plan view of the power converter as viewed from a second storage space.

FIG. 4 is a cross-sectional view taken along IV-IV line of FIG. 3.

FIG. 5 is an exploded perspective view for explaining arrangement of a Y-capacitor in the second storage space.

FIG. 6 is a perspective view for explaining the arrangement of the Y-capacitor in the second storage space.

FIG. 7 is a perspective view of the Y-capacitor.

FIG. 8 is a cross-sectional view of the Y-capacitor taken along VII-VII line in FIG. 7.

FIG. 9 is a plan view of the Y-capacitor excluding a Y-capacitor case and a coating resin as viewed from an exposed surface.

FIG. 10 is a plan view illustrating arrangement of the Y-capacitor in a case.

### DETAILED DESCRIPTION

To begin with, examples of relevant techniques will be described.

A conventional power converter according to a comparative example includes a switching element, and two Y-capacitors for reducing noise current generated by the switching element.

The two Y-capacitors of the power converter of the comparative example are disposed to face each other. A mutual inductance between the two Y-capacitors is large. As a result, for example, a magnetic field generated around a noise current flowing through one Y-capacitor is likely to generate an induced voltage in the other Y-capacitor that causes a noise current to flow in an opposite direction to the noise current flowing through the one Y-capacitor. There is a concern that the induced voltage may impede the flow of noise current to the other Y-capacitor. In such an arrangement, there is a risk that noise reduction performance of the Y-capacitors will not be fully exhibited.

In contrast to the comparative example, according to a power converter and a Y-capacitor of the present disclosure, noise reduction performance can be improved.

According to one aspect of the present disclosure, a power converter includes an inverter that converts electric power supplied from a battery. The power converter has a Y-capacitor for reducing noise generated in the inverter. The power converter also includes a case that houses the inverter and the Y-capacitor. The Y-capacitor includes a P-side Y-capacitor element, which has a first terminal electrically connected to the inverter and a second terminal electrically connected to the case. The Y-capacitor also includes an N-side Y-capacitor element, which has a third terminal electrically connected to the inverter and a fourth terminal electrically connected to the case. Additionally, the Y-capacitor has a GND busbar connected to the second terminal, the fourth terminal, and the case. The GND busbar connects the P-side Y-capacitor element and the N-side Y-capacitor element with ground. The P-side Y-capacitor element and the N-side Y-capacitor element do not face each other either in a first direction, in which the first terminal and the second terminal are arranged, or in a second direction, in which the third terminal and the fourth terminal are arranged.

According to this configuration, since the P-side Y-capacitor element and the N-side Y-capacitor element are not opposed to each other, an induced voltage is difficult to be generated from one Y-capacitor element to the other Y-capacitor element. Concerns that this may impede the flow of noise current to the other Y-capacitor can be allayed. As a result, the noise reduction performance of the Y-capacitor is fully exhibited.

The following describe embodiments for carrying out the present disclosure with reference to the drawings. In each embodiment, parts corresponding to the elements described in the preceding embodiments are denoted by the same reference numerals, and redundant explanation may be omitted. When only a part of the configuration is described in each embodiment, another embodiment described previously may be applied to the other parts of the configuration.

It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

### <In-vehicle System>

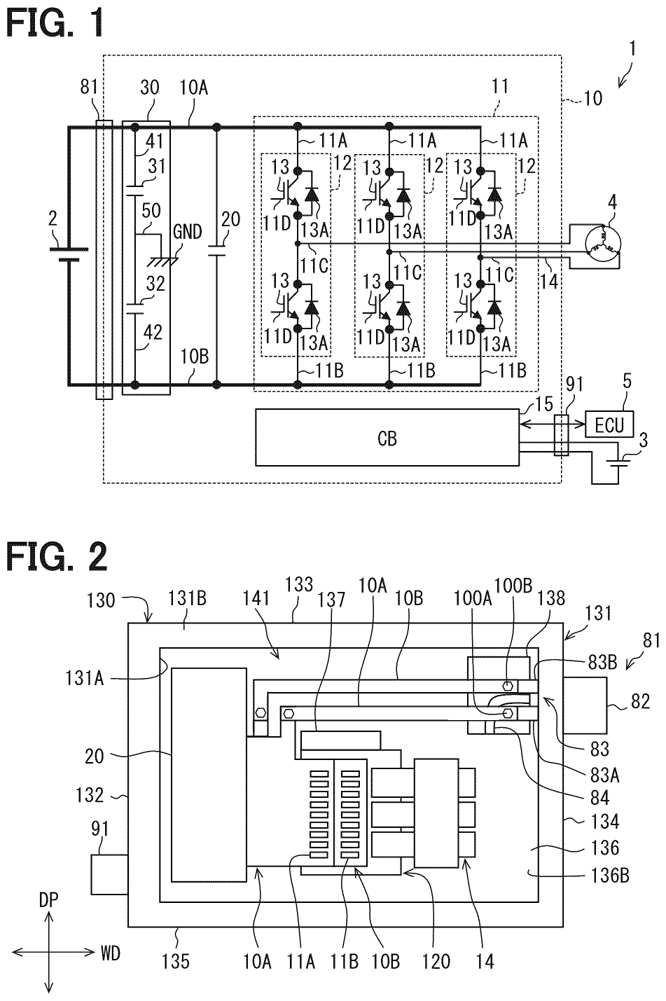

FIG. 1 is an electric circuit diagram of a power converter 10 mounted on an in-vehicle system 1. The in-vehicle system 1 has a high-voltage battery 2, a low-voltage battery 3, a motor generator 4, a controller 5, and the power converter 10. A vehicle on which the in-vehicle system 1 is mounted is a hybrid vehicle that can run by switching between and/or combining driving force of an engine and the driving force of the motor generator 4.

The power converter 10 includes high-voltage wires 10A, 10B, an inverter 11, a control circuit board 15, a smoothing capacitor 20, a Y-capacitor 30, a high-voltage connector 81, and a low-voltage connector 91. A high-voltage wire 10A is a wiring connected to a positive electrode of the high-voltage battery 2. The high-voltage wire 10A may be referred to as a P-side high-voltage wire 10A or a first high-voltage wire. A high-voltage wire 10B is a wiring connected to a negative electrode of the high-voltage battery 2. The high-voltage wire 10B may be referred to as an N-side high-voltage wire 10B or a second high-voltage wire.

The inverter 11 is connected to the P-side high-voltage wire 10A and the N-side high-voltage wire 10B. The inverter 11 includes multiple semiconductor modules 12. A semiconductor module 12 includes two switching elements 13 and two diodes 13A. The two switching elements 13 are connected in series between the P-side high-voltage wire 10A and the N-side high-voltage wire 10B.

A P-side input terminal 11A connected to the high-voltage battery 2 is connected to a collector electrode of one of the two switching elements 13 provided on the P-side. An N-side input terminal 11B connected to the high-voltage battery 2 is connected to one emitter of the two switching elements 13 provided on the N-side. An anode of a diode 13A is connected to the emitter of the corresponding switching element 13. A cathode of the diode 13A is connected to the collector of the corresponding switching element 13.

A motor terminal 11C connected to the motor generator 4 is connected to the emitter of the P-side switching element 13 and the collector of the N-side switching element 13. The multiple switching elements 13 convert DC power supplied from the high-voltage battery 2 into AC power that can drive the motor generator 4. The converted electric power is supplied to the motor generator 4 via a connecting busbar 14.

The control circuit board 15 controls on/off of the multiple switching elements 13 using operating power supplied from the low-voltage battery 3. A control circuit for controlling the on/off of the multiple switching elements 13 is mounted on the control circuit board 15. Connection terminals 11D of the multiple switching elements 13 are connected to the control circuit board 15 by soldering. The connection terminals 11D of the multiple switching elements 13 are electrically connected to the control circuit.

The smoothing capacitor 20 mainly smoothens the DC voltage supplied from the high-voltage battery 2. The smoothing capacitor 20 is connected to the P-side high-voltage wire 10A and the N-side high-voltage wire 10B. The smoothing capacitor 20 is connected in parallel to the inverter 11. The high-voltage wires 10A, 10B electrically connect the inverter 11, the smoothing capacitor 20, and the high-voltage battery 2 together.

The Y-capacitor 30 mainly removes noise current generated by the inverter 11. The Y-capacitor 30 has two Y-capacitor elements 31, 32, two Y-capacitor busbars 41, 42, and a GND busbar 50. The two Y-capacitor elements 31, 32 are connected in series to the P-side high-voltage wire 10A and the N-side high-voltage wire 10B via the two Y-capacitor busbars 41, 42.

One of the two Y-capacitor elements 31, 32 provided on the P-side high-voltage wire 10A, may be referred to as a P-side Y-capacitor element 31. One of the two Y-capacitor busbars 41, 42 provided on the P-side Y-capacitor element 31, may be referred to as a P-side Y-capacitor busbar 41 or a P-side wire. The P-side Y-capacitor busbar 41 has a P-side first busbar terminal 41A connected to the P-side Y-capacitor element 31, and a P-side second busbar terminal 41B connected to the P-side high-voltage wire 10A. The P-side Y-capacitor busbar 41 extends to connect a P-side first busbar terminal 41A and a P-side second busbar terminal 41B. The P-side Y-capacitor element 31 is electrically connected to the P-side high-voltage wire 10A via the P-side Y-capacitor busbar 41.

Similarly, one of the two Y-capacitor elements 31, 32 provided on the N-side high-voltage wire 10B, may be referred to as an N-side Y-capacitor element 32. One of the two Y-capacitor busbars 41, 42 provided on the N-side Y-capacitor element 32, may be referred to as an N-side Y-capacitor busbar 42 or an N-side wire. The N-side Y-capacitor busbar 42 has an N-side first busbar terminal 42A connected to the N-side Y-capacitor element 32, and an N-side second busbar terminal 42B connected to the N-side high-voltage wire 10B. The N-side Y-capacitor busbar 42 extends to connect the N-side first busbar terminal 42A and an N-side second busbar terminal 42B. The N-side Y-capacitor element 32 is electrically connected to the N-side high-voltage wire 10B via the N-side Y-capacitor busbar 42.

The GND busbar 50 has a P-side GND terminal 51 connected to the P-side Y-capacitor element 31, an N-side GND terminal 52 connected to the N-side Y-capacitor element 32, and a case connecting terminal 54 connected to a case 130. The GND busbar 50 extends to connect the P-side GND terminal 51, the N-side GND terminal 52, and the case connecting terminal 54. The GND busbar 50 has the P-side GND terminal 51, the N-side GND terminal 52, and the extension portion 53 connecting the P-side GND terminal 51 and the N-side GND terminal 52. The extension portion 53 can also be said to have the case connecting terminal 54.

The P-side Y-capacitor element 31 and the N-side Y-capacitor element 32 are electrically and thermally connected via the GND busbar 50. The GND busbar 50 is connected to the Y-capacitor elements 31, 32 and is electrically and thermally connected to the case 130.

The GND busbar 50 is electrically connected to a body ground such as a chassis via the case 130. The Y-capacitor elements 31, 32 direct the noise current generated by the inverter 11 through the GND busbar 50 and case 130 to the body ground. This removes the noise current from the inverter 11. Furthermore, the Y-capacitor elements 31, 32 can remove not only the noise current generated by the inverter 11 but also the noise current flowing through the high-voltage wires 10A, 10B.

The high-voltage connector 81 is a supply port through which high-voltage power is supplied from the high-voltage battery 2. The high-voltage wires 10A, 10B and the Y-capacitor busbars 41, 42 are electrically connected to the high-voltage connector 81. High voltage power is supplied from the high-voltage battery 2 to the inverter 11, the smoothing capacitor 20, and the Y-capacitor 30 via the high-voltage connector 81. In addition to the high-voltage battery 2, a signal wire 84 for transmitting an interlock signal is connected to the high-voltage connector 81. One end of the signal wire 84 is connected to the high-voltage connector 81, and the other end is connected to the control circuit board 15. The high-voltage wires 10A, 10B may be referred to as first wires. The Y-capacitor busbars 41, 42 may be referred to as second wires.

The low-voltage connector 91 is a supply port through which low-voltage power is supplied from the low-voltage battery 3. The control circuit board 15 is electrically connected to the low-voltage connector 91. A low-voltage power is supplied from the low-voltage battery 3 to the control circuit board 15 via the low-voltage connector 91. In addition to the low-voltage battery 3, the low-voltage connector 91 is electrically connected to the controller 5 as a host ECU, for example. A control circuit mounted on the control circuit board 15 cooperates with the controller 5 to control the inverter 11 and auxiliary devices included in the vehicle.

### <Mechanical Configuration of Power Converter>

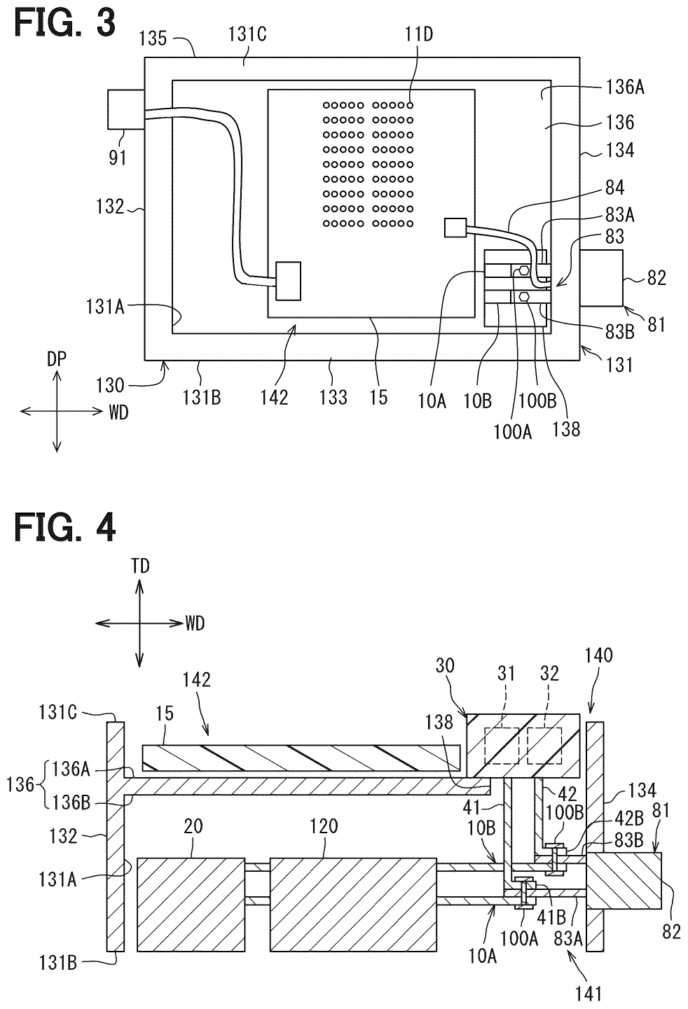

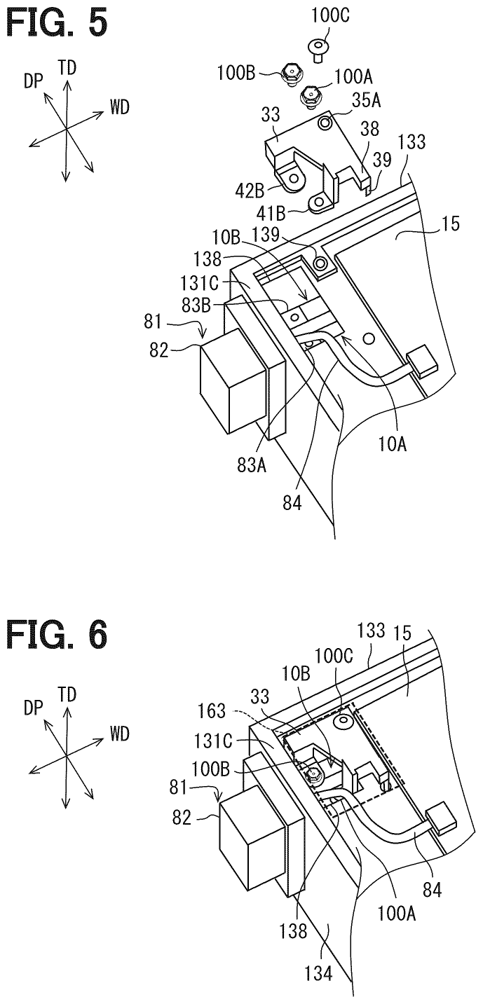

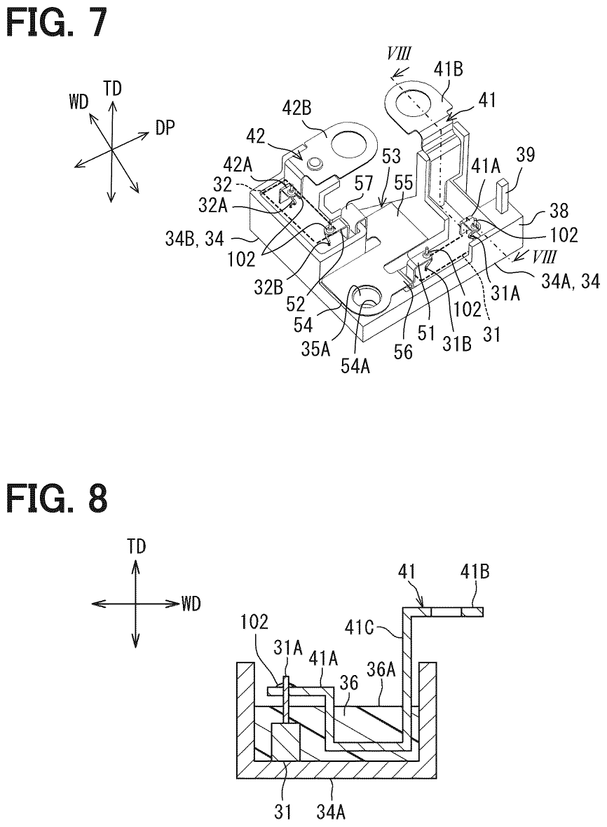

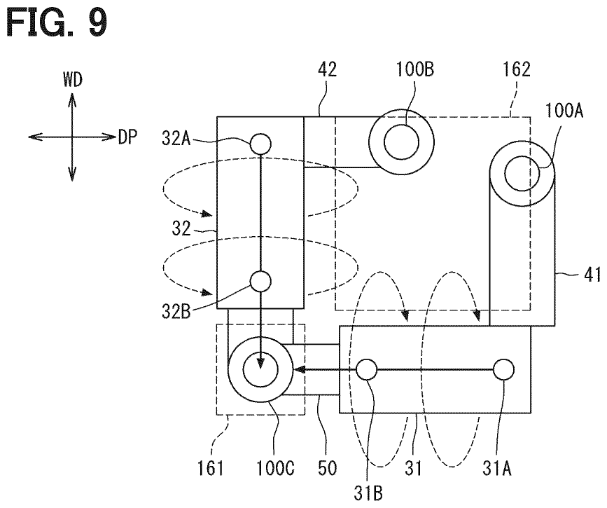

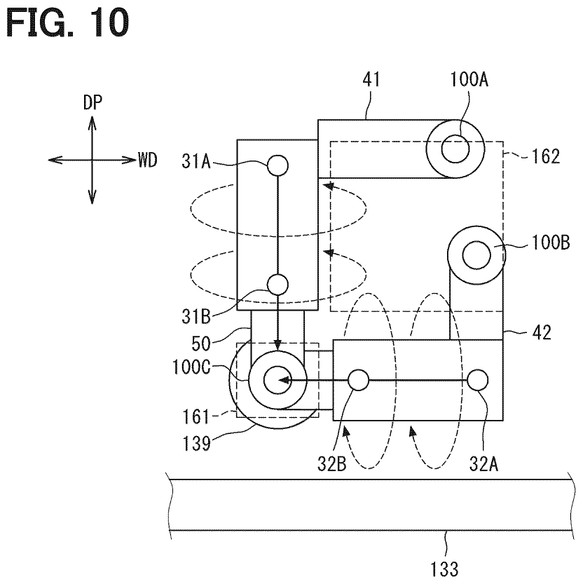

Before describing a mechanical configuration of the power converter 10, the drawings will be described. FIG. 2 is a plan view of the power converter 10 as viewed from a first storage space 141. FIG. 3 is a plan view of the power converter 10 as viewed from a second storage space 142. FIG. 4 is a cross-sectional view taken along IV-IV line of FIG. 3. FIG. 5 is an exploded perspective view for explaining arrangement of the Y-capacitor 30 in the second storage space 142. FIG. 6 is a perspective view for explaining arrangement of the Y-capacitor 30 in the second storage space 142. FIG. 7 is a perspective view of the Y-capacitor 30. FIG. 8 is a cross-sectional view of the Y-capacitor 30 taken along VII-VII line in FIG. 7. FIG. 9 is a plan view of the Y-capacitor 30 as viewed from an exposed surface 36A. FIG. 10 is a plan view illustrating arrangement of the Y-capacitor 30 in the case 130.

In the present embodiment, as an example, of the two high-voltage wires 10A, 10B, one provided on a first opening 131B side is described as the P-side high-voltage wire 10A. The one provided on a second opening 131C side is described as the N-side high-voltage wire 10B. However, the P-side high-voltage wire 10A and the N-side high-voltage wire 10B are not limited to this. Of the two high-voltage wires 10A, 10B, the one provided on the first opening 131B side may be regarded as the N-side high-voltage wire 10B. The one provided on the second opening 131C side may be regarded as the P-side high-voltage wire 10A. The configuration described below is merely one example of the present embodiment.

In addition to the components described above, the power converter 10 has the following elements. The power converter 10 includes a P-side connection member 100A, an N-side connection member 100B, a GND connection member 100C, a solder 102, a cooler 110, and the case 130. The P-side connection member 100A, the N-side connection member 100B, the GND connection member 100C, and the solder 102 will be described later as appropriate. The semiconductor modules 12 and the cooler 110 constitute a power module 120. The cooler 110 has a layered cooling structure. The cooler 110 includes a supply pipe 111, a discharge pipe 113, and relay pipes 112. The relay pipes 112 are arranged in a ladder-like manner between the supply pipe 111 and the discharge pipe 113. The supply pipe 111 and the discharge pipe 113 are connected via the relay pipes 112 in a manner that allows coolant to flow therethrough.

The semiconductor modules 12 are individually housed between the adjacent relay pipes 112. The semiconductor module 12 is sandwiched between the adjacent relay pipes 112. The semiconductor module 12 is housed in the cooler 110 to form the power module 120. The heat of the semiconductor module 12 is easily dissipated to the relay pipe 112 efficiently. The cooler 110 is fixed to the case 130. Since the coolant flows inside the cooler 110, the temperature of the cooler 110 is low. Since the case 130 is fixed to the cooler 110, the temperature of the case 130 is also low.

### <Case>

The case 130 forms a part of a container. The case 130 is made of a metal material. The case 130 is formed by, for example, aluminum die casting. The case 130 includes a frame 131 and a partition wall 136. The frame 131 extends in a first direction and has a closed annular enclosure shape centered on an axis along the first direction. The frame 131 has two ends spaced apart in the first direction. One end of the frame 131 defines the first opening 131B that opens in the first direction. Another end of the frame 131 defines the second opening 131C that opens in a width direction. As an example, the first opening 131B is provided lower than the second opening 131C in the gravity direction.

The partition wall 136 is provided inside the frame 131 and divides the storage space 140 inside the frame 131 into two. The partition wall 136 may also be referred to as an inner wall. The partition wall 136 has a flat shape with a small thickness in one direction. The partition wall 136 has a front surface 136A aligned in one direction and a back surface 136B on a rear side thereof. The surface 136A is provided on the second opening 131C side. The back surface 136B is provided on the first opening 131B side.

In addition, since the one direction coincides with a plate thickness direction of the partition wall 136, it may be referred to as a thickness direction TD. A depth direction perpendicular to the thickness direction TD may be referred to as a depth direction DP or a first direction. A width direction perpendicular to the thickness direction TD and the depth direction DP may be referred to as a width direction WD or a second direction. A direction perpendicular to the thickness direction TD may be referred to as a planar direction. The planar direction is a direction along the width direction WD and the depth direction DP.

The frame 131 has two walls spaced apart from each other in the width direction WD and two walls spaced apart from each other in the depth direction DP. The frame 131 includes a first wall portion 132 and a third wall portion 134 that are spaced apart from each other in the width direction WD, and a second wall portion 133 and a fourth wall portion 135 that are spaced apart from each other in the depth direction DP. The first wall portion 132 to the fourth wall portion 135 are arranged in order in a clockwise direction. The first wall portion 132 to the fourth wall portion 135 are integrally connected to form the frame 131.

The partition wall 136 is provided on an inner surface 131A of the frame 131 to divide the storage space 140 in the thickness direction TD. The storage space 140 is divided into the first storage space 141 and the second storage space 142 by the partition wall 136. The first storage space 141 is defined by a portion of the frame 131 on the side of the first opening 131B and the back surface 136B of the partition wall 136. The second storage space 142 is defined by a portion of the frame 131 on the second opening 131C side and the surface 136A of the partition wall 136.

The partition wall 136 is provided with through holes 137 for passing the connection terminals 11D extending from the semiconductor module 12 therethrough, and a wiring hole 138 for passing the signal wire 84 therethrough. In addition to passing the signal wire 84 through the wiring hole 138, the wiring hole 138 also serves the following object. The wiring hole 138 is adapted to receive a tool for mechanically connecting the electrical components housed in the first storage space 141 and the electrical components housed in the second storage space 142. The through holes 137 and the wiring hole 138 are holes that penetrate the partition wall 136 in the thickness direction TD. As an example, the through holes 137 are provided at approximately a center of the partition wall 136 in the width direction WD. The wiring hole 138 is provided at a position closer to the third wall portion 134 than the through holes 137.

In the first storage space 141, the high-voltage wires 10A, 10B, the smoothing capacitor 20, and the power module 120 are stored. The connection terminal 11D of the semiconductor module 12 extends from the through holes 137 toward the second storage space 142. The control circuit board 15 and the Y-capacitor 30 are housed in the second storage space 142. The control circuit board 15 is attached to the partition wall 136 so that a portion of the control circuit board 15 overlaps with the through holes 137. The first storage space 141 may be referred to as a high voltage area because it is an area in which high voltage components to which high voltage power is supplied from the high-voltage battery 2 are stored. The second storage space 142 may be referred to as a low-voltage area because it is an area in which low-voltage components to which low-voltage power is supplied from the low-voltage battery 3 are stored.

The Y-capacitor 30 is provided in the second storage space 142 so that the Y-capacitor busbars 41, 42 pass through the wiring hole 138. The Y-capacitor 30 is attached to a side of the wiring hole 138 in the partition wall 136 so that the Y-capacitor busbars 41, 42 pass through the wiring hole 138. The P-side Y-capacitor element 31 and the N-side Y-capacitor element 32 are housed in the second storage space 142. The Y-capacitor busbars 41, 42 extend through the wiring hole 138 from the second storage space 142 to the first storage space 141.

Further, a base 139 to which the GND busbar 50 is fastened is provided near the wiring hole 138 in the partition wall 136. The base 139 is adjacent to the wiring hole 138 in the width direction WD. The base 139 is adjacent to the second wall portion 133. The base 139 is a protrusion that protrudes from the surface 136A of the partition wall 136. A tip of the protrusion of the base 139 is formed with a hole into which a bolt or the like can be fastened. The base 139 is provided on the partition wall 136 so as to be adjacent to the second wall portion 133. A hole 54A of the case connecting terminal 54 is fastened to the base 139 via the GND connection member 100C, whereby the Y-capacitor elements 31, 32 are electrically connected to the partition wall 136. The partition wall 136 and the frame 131 are electrically connected. The Y-capacitor elements 31, 32 electrically connected to the base 139 are electrically connected to a body ground such as a chassis via the partition wall 136 and the frame 131.

The power module 120 is provided at approximately a center of the first storage space 141 in the width direction WD. The power module 120 is provided on the fourth wall portion 135 side in the depth direction DP. The smoothing capacitor 20 is provided at a position closer to the first wall portion 132 than the power module 120 in the width direction WD. The smoothing capacitor 20 is provided across from the second wall portion 133 to the fourth wall portion 135 in the depth direction DP. Furthermore, the high-voltage connector 81 is provided on the third wall portion 134. The high-voltage connector 81 is provided at a position closer to the second wall portion 133 than the power module 120 in the depth direction DP.

The high-voltage connector 81 has the supply portion 82 and the distribution portion 83. The supply portion 82 is a portion to which high voltage power is supplied from the high-voltage battery 2. The distribution portion 83 is a portion where power is distributed to the high-voltage wires 10A, 10B and the Y-capacitor busbars 41, 42.

A portion of the distribution portion 83 connected to the P-side high-voltage wire 10A and the P-side Y-capacitor busbar 41 may be referred to as a P-side distribution portion 83A. A portion of the distribution portion 83 that is connected to the N-side high-voltage wire 10B and the N-side Y-capacitor busbar 42 may be referred to as an N-side distribution portion 83B. The P-side high-voltage wire 10A, the P-side Y-capacitor busbar 41, and the P-side distribution portion 83A are electrically and mechanically connected together via the P-side connection member 100A. The N-side high-voltage wire 10B, the N-side Y-capacitor busbar 42, and the N-side distribution portion 83B are connected electrically and mechanically via the N-side connection member 100B. The P-side connection member 100A may be referred to as a first connection member. The N-side connection member 100B may be referred to as a second connection member.

The wiring hole 138 is formed in the partition wall 136 so as to be adjacent to a portion of the third wall portion 134 where the high-voltage connector 81 is provided. The Y-capacitor 30 is provided in the second storage space 142 so as to cover the wiring hole 138. The Y-capacitor 30 is attached to a side of the wiring hole 138 in the partition wall 136 so that the Y-capacitor busbars 41, 42 pass through the wiring hole 138. The P-side connection member 100A and the N-side connection member 100B are provided at positions overlapping the wiring holes 138 in the thickness direction TD.

### <Mechanical Configuration of Y-capacitor>

The Y-capacitor 30 further includes a Y-capacitor case 33 and a coating resin 36. The Y-capacitor case 33 holds and houses the Y-capacitor elements 31, 32, the Y-capacitor busbars 41, 42, and the GND busbar 50. The Y-capacitor case 33 includes two element storage portions 34 for housing the Y-capacitor elements 31, 32 respectively, and a connecting portion 35 for holding the GND busbar 50.

The two element storage portions 34 have a box shape with a bottom that is open on one end in the thickness direction TD. The two element storage portions 34 are connected via the connecting portion 35. The connecting portion 35 has a flat shape extending in a planar direction. The connecting portion 35 is provided with a hole 35A penetrating therethrough in the thickness direction TD. The GND busbar 50 is provided in the connecting portion 35 so that the hole 54A overlaps with the hole 35A. The Y-capacitor 30 is further provided in the second storage space 142 such that holes 54A, 35A overlap with the hole of base 139 in the thickness direction TD. The GND connection member 100C is passed through the overlapping three holes. The Y-capacitor 30 is electrically and mechanically connected to the base 139 by the GND connection member 100C. The Y-capacitor 30 is fastened to the base 139 so as to cover the wiring hole 138.

The element storage portion 34 housing the P-side Y-capacitor element 31 may be referred to as a P-type element storage portion 34A or a first storage portion. The element storage portion 34 housing the N-side Y-capacitor element 32 may be referred to as an N-type element storage portion 34B or a second storage portion. The connecting portion 35 is provided to connect a wall portion provided on the inner side of the P-type element storage portion 34A in the planar direction with a wall portion provided on the inner side of the N-type element storage portion 34B in the planar direction. The hole 35A is provided at a corner where the two wall portions of the connecting portion 35 are joined.

An opening of the P-type element storage portion 34A has a substantially L-shape extending in the width direction WD and the depth direction DP when viewed in the thickness direction TD. A part of the L-shape of the P-type element storage portion 34A is adjacent to the hole 35A. The P-type element storage portion 34A extends in the depth direction along an edge of the wiring hole 138 so as to move away from the hole 35A. Furthermore, the P-type element storage portion 34A extends in the width direction from an end away from the hole 35A toward the wiring hole 138. The P-side Y-capacitor element 31 is housed in a portion of P-type element storage portion 34A extending in the depth direction DP.

The P-side Y-capacitor element 31 includes a P-side first element terminal 31A connected to the P-side first busbar terminal 41A, and a P-side second element terminal 31B connected to the P-side GND terminal 51. The P-side first element terminal 31A and the P-side second element terminal 31B extend in the thickness direction TD so as to move away from the P-side Y-capacitor element 31. The P-side Y-capacitor element 31 is housed in the P-type element storage portion 34A so that the P-side first element terminal 31A and the P-side second element terminal 31B are aligned in the depth direction DP. More specifically, the P-side Y-capacitor element 31 is housed in a portion of the P-type element storage portion 34A extending in the depth direction DP. The P-side second element terminal 31B is provided closer to the GND connecting portion 100C than the P-side first element terminal 31A. In other words, the P-side first element terminal 31A is provided away from the GND connection member 100C than the P-side second element terminal 31B. The P-side first element terminal 31A may be referred to as a first terminal. The P-side second element terminal 31B may be referred to as a second terminal.

The P-side Y-capacitor element 31, a portion of the P-side Y-capacitor busbar 41, and a portion of the GND busbar 50 are housed in the P-type element storage portion 34A. The P-side Y-capacitor element 31, a portion of the P-side Y-capacitor busbar 41, and a portion of the GND busbar 50 are covered with the coating resin 36. The P-side first element terminal 31A, the P-side second element terminal 31B, the P-side first busbar terminal 41A, the P-side second busbar terminal 41B, and the P-side GND terminal 51 are exposed from an exposed surface 36A of the coating resin 36.

The P-side first element terminal 31A exposed from the exposed surface 36A and the P-side first busbar terminal 41A are connected via solder 102. The P-side second element terminal 31B exposed from the exposed surface 36A is connected to the P-side GND terminal 51 via solder 102.

The P-side Y-capacitor busbar 41 has a main portion 41C that connects the P-side first busbar terminal 41A and the P-side second busbar terminal 41B. The main portion 41C has a portion extending in the planar direction in the P-type element storage portion 34A, and a portion extending in the thickness direction TD. The main portion 41C has two portions extending in the thickness direction TD. The two portions extending in the thickness direction TD are provided at both ends of a portion extending in the planar direction in the P-type element storage portion 34A. The P-side first busbar terminal 41A is provided at an end of one of the portions extending in the thickness direction TD. The P-side second busbar terminal 41B is provided at another end of the portions extending in the thickness direction TD. The P-side second busbar terminal 41B and the P-side high-voltage wire 10A are fastened to each other via the P-side connection member 100A.

The P-side Y-capacitor busbar 41 is soldered with solder 102 to the P-side first element terminal 31A outside the coating resin 36. The P-side Y-capacitor busbar 41 extends from a connecting portion with the P-side first element terminal 31A toward a connecting portion with the P-side high-voltage wire 10A. The P-side Y-capacitor busbar 41 is arranged so that a part of its length is covered with the coating resin 36. A positioning base 38 is formed on the wall of the P-type element storage portion 34A away from the GND connection member 100C. The positioning base 38 extends away from the GND connection member 100C. A positioning portion 39 protrudes from the positioning base 38 toward the partition wall 136. Of sides of the Y-capacitor case 33, a side that extends in the depth direction DP and is a long side from an edge of the positioning portion 39 furthest from the hole 35A is the long side.

An opening of the N-type element storage portion 34B has a substantially rectangular shape extending in the width direction WD when viewed in the thickness direction TD. A part of the rectangular shape of the N-type element storage portion 34B is adjacent to the hole 35A. The N-type element storage portion 34B extends in the width direction along an edge of the wiring hole 138 so as to move away from the hole 35A. The N-side Y-capacitor element 32 is housed in the N-type element storage portion 34B.

The N-side Y-capacitor element 32 includes an N-side first element terminal 32A connected to the N-side first busbar terminal 42A, and an N-side second element terminal 32B connected to the N-side GND terminal 52. The N-side first element terminal 32A and the N-side second element terminal 32B extend in the thickness direction TD away from the N-side Y-capacitor element 32. The N-side Y-capacitor element 32 is housed in the N-type element storage portion 34B such that the N-side first element terminal 32A and the N-side second element terminal 32B are aligned in the width direction WD. The N-side second element terminal 32B is provided closer to the GND connecting portion 100C than the N-side first element terminal 32A. In other words, the N-side first element terminal 32A is provided farther from the GND connection member 100C than the N-side second element terminal 32B. The N-side first element terminal 32A may be referred to as a third terminal. The N-side second element terminal 32B may be referred to as a fourth terminal.

The N-type element storage portion 34B is provided with the N-side Y-capacitor element 32, a portion of the N-side Y-capacitor busbar 42, and a portion of the GND busbar 50. The N-side Y-capacitor element 32, a portion of the N-side Y-capacitor busbar 42, and a portion of the GND busbar 50 are covered with the coating resin 36. The N-side first element terminal 32A, the N-side second element terminal 32B, the N-side first busbar terminal 42A, the N-side second busbar terminal 42B, and the N-side GND terminal 52 are exposed from the exposed surface 36A of the coating resin 36.

The N-side first element terminal 32A exposed from the exposed surface 36A and the N-side first busbar terminal 42A are connected via the solder 102. The N-side second element terminal 32B exposed from the exposed surface 36A is connected to the N-side GND terminal 52 via the solder 102.

The N-side Y-capacitor busbar 42 has a main portion that connects the N-side first busbar terminal 42A and the N-side second busbar terminal 42B. A detailed description of the N-side Y-capacitor busbar 42 will be omitted. The N-side Y-capacitor busbar 42 is soldered with the solder 102 to the N-side first element terminal 32A outside the coating resin 36. The N-side Y-capacitor busbar 42 extends from a connecting portion with the N-side first element terminal 32A toward a connecting portion with the N-side high-voltage wire 10B. The N-side Y-capacitor busbar 42 is arranged so that a part of the busbar is covered with the coating resin 36. Of sides of the Y-capacitor case 33, a side that extends in the width direction WD and is a long side from an edge of the N-type element storage portion 34B furthest from the hole 35A is the long side.

As described above, the P-side Y-capacitor element 31 is provided in the P-type element storage portion 34A so that the P-side first element terminal 31A and the P-side second element terminal 31B are aligned in the depth direction DP. The N-side Y-capacitor element 32 is housed in the N-type element storage portion 34B such that the N-side first element terminal 32A and the N-side second element terminal 32B are aligned in the width direction WD. An arrangement of the N-side Y-capacitor element 32 is the same as the arrangement obtained by rotating the P-side Y-capacitor element 31 by 90 degrees around the hole 35A. In other words, the arrangement of the P-side Y-capacitor element 31 is equivalent to the arrangement obtained by rotating the N-side Y-capacitor element 32 by 90 degrees around the hole 35A.

The P-side Y-capacitor element 31 and the N-side Y-capacitor element 32 do not face each other in both the width direction WD and the depth direction DP. The P-side Y-capacitor element 31 and the N-side Y-capacitor element 32 do not overlap with each other in both the width direction WD and the depth direction DP. An electric current flows in the P-side Y-capacitor element 31 from the P-side first element terminal 31A to the P-side second element terminal 31B. The electric current flows through the P-side Y-capacitor element 31 in the depth direction DP. In the P-side Y-capacitor element 31, a magnetic field is generated in a radial direction with the depth direction DP as the central axis. The electric current flows in the N-side Y-capacitor element 32 from the N-side first element terminal 32A to the N-side second element terminal 32B. The electric current flows through the N-side Y-capacitor element 32 in the width direction WD.

A direction in which the electric current mainly flows through the P-side Y-capacitor element 31 and a direction in which the electric current mainly flows through the N-side Y-capacitor element 32 are perpendicular to each other. A mutual inductance between the P-side Y-capacitor element 31 and the N-side Y-capacitor element 32 is small. The generation of an induced voltage in the N-side Y-capacitor element 32 due to the magnetic field generated in the P-side Y-capacitor element 31 is easily reduced. The generation of the induced voltage in the P-side Y-capacitor element 31 due to the magnetic field generated in the N-side Y-capacitor element 32 is easily reduced. The direction in which the electric current flows through the P-side Y-capacitor element 31 and the direction in which the electric current flows through the N-side Y-capacitor element 32 are not limited to being perpendicular to each other.

### <Arrangement of Connection Members>

As described above, the Y-capacitor 30 is provided in the second storage space 142 so that the Y-capacitor 30 covers the wiring hole 138. An extension portion 53 is provided on the connecting portion 35 so that the hole 54A overlaps with the hole 35A. The extension portion 53 extends along the connecting portion 35. The extension portion 53 has a case connecting terminal 54. The case connecting terminal 54 is provided with a hole 54A. The GND connection member 100C is passed through the base 139, the hole 35A, and the hole 54A. The Y-capacitor 30 is fixed to the partition wall 136 via the GND connection member 100C. The P-side connection member 100A and the N-side connection member 100B overlap the wiring hole 138 when viewed in the thickness direction TD. The GND connection member 100C does not overlap the wiring hole 138 when viewed in the thickness direction TD.

FIG. 9 is a plan view of the Y-capacitor 30 excluding the Y-capacitor case 33 and the coating resin 36 as viewed from the exposed surface 36A. A region where a region extending the P-side Y-capacitor element 31 in the depth direction DP overlaps with a region extending the N-side Y-capacitor element 32 in the width direction WD is a first overlap region 161. The GND connection member 100C is provided in the first overlap region 161. A region where a region extending the P-side Y-capacitor element 31 in the width direction WD overlaps with a region extending the N-side Y-capacitor element 32 in the depth direction DP is a second overlap region 162. In the second overlap region 162, a part of the P-side connection member 100A and the N-side connection member 100B are provided. The P-side connection member 100A and the N-side connection member 100B are provided in a rectangular area 163 having two sides extending in the depth direction DP and width direction from the hole 35A. The rectangular area 163 corresponds to an outer contour of the Y-capacitor case 33.

As shown in FIG. 10, the base 139 is provided closer to a side wall of the frame 131 that is closest to the Y-capacitor elements 31, 32 than the Y-capacitor elements 31, 32. More specifically, the base 139 is provided closer to the second wall portion 133 than the P-side connection member 100A and the N-side connection member 100B in the depth direction DP. The GND connection member 100C, the N-side connection member 100B, and the P-side connection member 100A are arranged in this order, moving away from the second wall portion 133. The GND connection member 100C is provided between the P-side Y-capacitor element 31 and the second wall portion 133. The GND connection member 100C is provided closer to the second wall portion 133 than the P-side Y-capacitor element 31.

### <Actions and Effects>

In recent years, with an increase in switching speed in inverters and tightening of EMC standards, the FM band, which was not an issue before, is becoming an issue. There is a demand for reducing noise in this FM band. Therefore, in order to remove noise in the FM band, it is required to mount the Y-capacitor on the power converter. A power converter according to a comparative exam has two Y-capacitor elements. The two Y-capacitor elements in the power converter are arranged opposite each other.

A noise current generated from the inverter flows through the two Y-capacitor elements. Ends of the two Y-capacitor elements are connected to ground. Since the two Y-capacitor elements are disposed opposite each other, a mutual inductance between one Y-capacitor element and the other Y-capacitor element is large. For this reason, for example, a magnetic field generated around a noise current flowing through one Y-capacitor element is likely to generate an induced voltage in the other Y-capacitor element. A noise current flows through the other Y-capacitor element in the opposite direction to the noise current flowing through one Y-capacitor element. There is a concern that this may impede the flow of noise current to the other Y-capacitor. In such an arrangement, there is a risk that noise reduction performance of the Y-capacitors will not be fully exhibited.

In the present embodiment, the arrangement of the two Y-capacitor elements is devised so that the noise reduction performance of the Y-capacitor is fully exhibited. The power converter 10 of the present embodiment includes the inverter 11, the Y-capacitor 30 that removes noise generated in the inverter 11, and the case 130 that houses these components. The Y-capacitor 30 has the two Y-capacitor elements 31, 32, the two Y-capacitor busbars 41, 42, and the GND busbar 50. The P-side Y-capacitor element 31 has the P-side first element terminal 31A and the P-side second element terminal 31B arranged in the depth direction DP. The N-side Y-capacitor element 32 has the N-side first element terminal 32A and the N-side second element terminal 32B arranged in the width direction WD.

The GND busbar 50 is connected to the P-side second element terminal 31B, the N-side second element terminal 32B, and the connecting portion 35. The GND busbar 50 connects the P-side Y-capacitor element 31 and the N-side Y-capacitor element 32 to ground. The P-side Y-capacitor element 31 and the N-side Y-capacitor element 32 do not face each other in both the width direction WD and the depth direction DP. According to this, the mutual inductance between the P-side Y-capacitor element 31 and the N-side Y-capacitor element 32 is small. Therefore, a magnetic field generated around a noise current flowing through one Y-capacitor element does not easily induce a voltage in the other Y-capacitor element. A noise current is unlikely to flow in the other Y-capacitor element in the opposite direction to the noise current flowing in one Y-capacitor element. The noise current is less likely to flow from the other Y-capacitor element toward the inverter 11. The deterioration of the noise removal performance can be reduced.

As described above, the depth direction DP and the width direction WD are perpendicular to each other. A direction in which the electric current mainly flows through the P-side Y-capacitor element 31 and a direction in which the electric current mainly flows through the N-side Y-capacitor element 32 are perpendicular to each other. As a result, interference between the magnetic field generated around the P-side Y-capacitor element 31 and the magnetic field generated around the N-side Y-capacitor element 32 can be reduced.

The GND connection member 100C is provided in the first overlap region 161. As a result, the noise current is allowed to flow to the ground via a short route for both the P-side Y-capacitor element 31 and the N-side Y-capacitor element 32. Since the route length is shortened, preventing noise current from leaking to the outside can be reduced. Furthermore, since a space can be utilized efficiently, a size of the Y-capacitor 30 can be reduced.

The P-side second element terminal 31B of the P-side Y-capacitor element 31 is provided closer to the GND connection member 100C than the P-side first element terminal 31A. The N-side second element terminal 32B of the N-side Y-capacitor element 32 is provided closer to the GND connection member 100C than the N-side first element terminal 32A. As a result, the noise current flows efficiently to the ground for both the P-side Y-capacitor element 31 and the N-side Y-capacitor element 32. Since the route length is shortened, preventing noise current from leaking to the outside can be reduced.

In the second overlap region 162, a part of the P-side connection member 100A and the N-side connection member 100B are provided. As a result, the wiring length of the P-side Y-capacitor busbar 41 and the N-side Y-capacitor busbar 42 can be shortened. Preventing leakage noise current from the P-side Y-capacitor busbar 41 and the N-side Y-capacitor busbar 42 can be reduced. Furthermore, since a space can be utilized efficiently, a size of the Y-capacitor can be reduced.

The base 139 is provided closer to the side wall of the frame 131 that is closest to the Y-capacitor elements 31, 32 than at least one of the Y-capacitor elements 31, 32. More specifically, the base 139 is provided closer to the second wall portion 133 than the P-side connection member 100A and the N-side connection member 100B in the depth direction DP. As a result, a distance between the base 139 and the frame 131 is shortened. Since a current path between the base 139 and the frame 131 is shortened, leakage of noise current to the outside can be easily reduced.

The storage space 140 is divided into the first storage space 141 and the second storage space 142 by the partition wall 136. The wiring hole 138 is provided in the partition wall 136 so as to penetrate therethrough in the thickness direction TD. The wiring hole 138 communicates the first storage space 141 and the second storage space 142. The Y-capacitor 30 is provided in the second storage space 142 so that the Y-capacitor busbars 41, 42 pass through the wiring hole 138. The base 139 is provided on the partition wall 136 at a portion on the second storage space 142 side. The first storage space 141 and the second storage space 142 are partitioned by the partition wall 136, and the Y-capacitor busbars 41, 42 are passed through holes. Therefore, the radiant heat from the inverter 11 is reduced from being transferred to the Y-capacitor elements 31, 32. The performance of the Y-capacitor elements 31, 32 is reduced from deteriorating. The noise suppression performance of the Y-capacitor elements 31, 32 is prevented from being degraded.

The P-side connection member 100A and the N-side connection member 100B are provided at positions overlapping with the wiring holes 138 in the thickness direction TD. There is no need to provide a hole for passing a tool for fastening the P-side connection member 100A and the N-side connection member 100B separately from the wiring hole 138. The number of wiring holes 138 can be limited. The radiant heat of the inverter 11 is prevented from being transferred to the Y-capacitors 31, 32. The noise removal performance of the Y-capacitors 31, 32 is prevented from being degraded.

Although the present disclosure has been described in accordance with the embodiments, it is understood that the present disclosure is not limited to the above embodiments or structures. The present disclosure encompasses various modified examples and modifications within an equivalent scope. In addition, although various combinations and modes are shown in the present disclosure, other combinations and modes including only one element, more elements, or less elements are also within the scope and idea of the present disclosure.

### Second Embodiment

In the first embodiment, a configuration has been described in which the P-side Y-capacitor element 31 and the N-side Y-capacitor element 32 do not face each other in both the width direction WD and the depth direction DP, but the arrangement of the P-side Y-capacitor element 31 and the N-side Y-capacitor element 32 is not limited to this. In a second embodiment, the P-side Y-capacitor element 31 and the N-side Y-capacitor element 32 may have a configuration in which parts of them do not face each other. As a result, the same effects as the first embodiment can be provided.

### Third Embodiment

In the first embodiment, a configuration has been described in which the GND connection member 100C is provided in the first overlap region 161, and a part of the P-side connection member 100A and the N-side connection member 100B are provided in the second overlap region 162, but this is not limited to this. In a third embodiment, a configuration can be adopted in which a part of the GND connection member 100C is provided in the first overlap region 161. A configuration can be adopted in which a part of the P-side connection member 100A and a part of the N-side connection member 100B are provided in the second overlap region 162. These configurations may be combined. As a result, the same effects as the first embodiment can be provided.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A power converter comprising:
an inverter configured to convert electric power supplied from a battery;
a Y-capacitor for reducing noise generated in the inverter; and
a case housing the inverter and the Y-capacitor, wherein
the Y-capacitor includes:
a P-side Y-capacitor element having a first terminal electrically connected to the inverter and a second terminal electrically connected to the case;
an N-side Y-capacitor element having a third terminal electrically connected to the inverter and a fourth terminal electrically connected to the case; and
a GND busbar connected to the second terminal, the fourth terminal, and the case and connecting the P-side Y-capacitor element and the N-side Y-capacitor element with ground, and
the P-side Y-capacitor element and the N-side Y-capacitor element do not face each other either in a first direction in which the first terminal and the second terminal are arranged, or in a second direction in which the third terminal and the fourth terminal are arranged.

2. The power converter according to claim 1, wherein
the first direction is perpendicular to the second direction.

3. The power converter according to claim 1, further comprising:
a GND connection member connecting the GND busbar and the case, wherein
at least a part of the GND connection member is provided in a first overlapping area where an area overlapping the P-side Y-capacitor element in the first direction and an area overlapping the N-side Y-capacitor element in the second direction overlap.

4. The power converter according to claim 3, wherein
the second terminal is provided closer to the GND connection member than the first terminal, and
the fourth terminal is provided closer to the GND connection member than the third terminal.

5. The power converter according to claim 4, further comprising:
a first high-voltage wire and a second high-voltage wire electrically connecting the inverter and the battery, wherein
the Y-capacitor further includes a P-side Y-capacitor wire connecting the first terminal and the first high-voltage wire, and an N-side Y-capacitor wire connecting the third terminal and the second high-voltage wire,
the power converter further comprising:
a first connection member connecting the P-side Y-capacitor wire and the first high-voltage wire; and
a second connection member connecting the N-side Y-capacitor wire and the second high-voltage wire, and
at least a part of the first connection member and at least a part of the second connection member are provided in a second overlapping area where an area overlapping the P-side Y-capacitor element in the second direction and an area overlapping the N-side Y-capacitor element in the first direction overlap.

6. The power converter according to claim 5, wherein
the case includes:
a frame housing the inverter and the Y-capacitor and connected to the ground;
an inner wall connected to an inner surface of the frame; and
a base provided on the inner wall and connected to the GND connection member, and
the base is provided near a side wall closest to the P-side Y-capacitor element and the N-side Y-capacitor element.

7. The power converter according to claim 6, wherein
the storage space surrounded by the frame is divided into two spaces by the inner wall,
the inverter, the first high-voltage wire, and the second high-voltage wire are provided in a first storage space surrounded by a part of the frame and the inner wall,
the Y-capacitor is provided in a second storage space surrounded by a remainder of the frame and the inner wall,
the base is provided on the inner wall in the second storage space,
the inner wall has a hole connecting the first storage space and the second storage space, and
the P-side Y-connector wire and the N-side Y-connector wire pass through the hole.

8. The power converter according to claim 7, wherein
the first connection member and the second connection member are provided at positions overlapping the holes in the first storage space.

9. The power converter according to claim 8, wherein
the Y-capacitor has a first storage portion for storing the P-side Y-capacitor element, a second storage portion for storing the N-side Y-capacitor element, and a connecting portion connecting the first storage portion and the second storage portion,
a portion of the GND busbar extends along the connecting portion, and
the portion of the GND busbar that extends along the connecting portion is fastened to the base.

10. A Y-capacitor for reducing noise generated in an inverter, comprising:
a P-side Y-capacitor element having a first terminal electrically connected to the inverter and a second terminal electrically connected to ground;
an N-side Y-capacitor element having a third terminal electrically connected to the inverter and a fourth terminal electrically connected to the ground; and
a GND busbar electrically connecting the second terminal, the fourth terminal, and the ground, wherein
the P-side Y-capacitor element and the N-side Y-capacitor element do not face each other either in a first direction in which the first terminal and the second terminal are arranged, or in a second direction in which the third terminal and the fourth terminal are arranged.
